(19) United States
(12) Patent Application Publication
(10) Pub. No.: US 2022/0114687 A1
(43) Pub. Date: Apr. 14, 2022

(54) PRIVILEGE ISSUING APPARATUS, METHOD, AND COMPUTER-READABLE MEDIUM

(71) Applicant: NEC Corporation, Minato-ku, Tokyo (JP)

(72) Inventors: Akane ARUGA, Tokyo (JP); Shigeki SHINODA, Tokyo (JP); Takumi OTANI, Tokyo (JP); Ikumi SAGA, Tokyo (JP); Yuzo SENDA, Tokyo (JP)

(73) Assignee: NEC Corporation, Minato-ku, Tokyo (JP)

(21) Appl. No.: 17/430,465

(22) PCT Filed: Nov. 26, 2019
(86) PCT No.: PCT/JP2019/046151

§ 371 Date: Aug. 12, 2021

(30) Foreign Application Priority Data
Feb. 15, 2019 (JP) 2019-026104

(51) Int. Cl. G06Q 50/26; G06Q 30/02

(52) U.S. Cl. CPC G06Q 50/265; G06Q 30/0202

(57) ABSTRACT

A scheduled boarding time acquiring unit acquires a scheduled boarding time of an airport user. A security checkpoint arrival time calculating unit calculates, based on the scheduled boarding time, a security checkpoint arrival time at which the airport user arrives at a security checkpoint. A security checkpoint congestion predicting unit acquires a time series prediction of congestion at the security checkpoint. A privilege determining unit determines, based on the security checkpoint arrival time and the time series prediction of congestion at the security checkpoint, privilege information to be issued to the airport user and its validity period. A privilege issuing unit issues, to the airport user, the privilege information determined by the privilege determining unit.

### TECHNICAL FIELD

The present disclosure relates to a privilege issuing apparatus, a method, and a computer-readable medium.

### BACKGROUND ART

Airport users use airport facilities to board an aircraft. FIG. 19 shows an airport facility. An airport facility 200 is roughly separated to a check-in area 201 and a boarding area 202, and a security checkpoint 203 is between the two areas. A user enters the check-in area 201 from an airport entrance, checks in, passes through the security checkpoint 203, and enters the boarding area 202. At the boarding time of the boarding aircraft, the user boards the aircraft from the boarding gate in the boarding area 202.

Airport users to board an aircraft need to pass through the security checkpoint 203 before boarding. If users arriving at the security checkpoint 203 per unit time exceeds the processing capability of the security checkpoint 203 (the number of users who can pass per unit time), a waiting time is caused at the security checkpoint 203.

As a related art, Patent Literature 1 discloses a facility congestion mitigating apparatus. Patent Literature 1 discloses that the schedules of the transportation facilities for accessing an airport are adjusted to reduce congestion in the airport. Patent Literature 1 further discloses that a mileage service is offered to users who arrive early at the airport. Patent Literature 1 further discloses that service staff and operating facilities are adjusted to reduce congestion.

As another related art, Patent Literature 2 discloses a guiding apparatus in an airport. The guiding apparatus disclosed in Patent Literature 2 calculates a staying time of an airport user. If the staying time is longer than a margin time, the guiding apparatus distributes privilege information depending on the staying time. The guiding apparatus distributes, for example, privilege information available in restaurants and the like to a user having a long staying time. On the other hand, the guiding apparatus distributes privilege information available in souvenir shops and the like to a user having a short staying time.

### CITATION LIST

### Patent Literature

Patent Literature 1: Japanese Unexamined Patent Application
Publication No. 2006-171943
Patent Literature 2: Japanese Unexamined Patent Application
Publication No. 2006-99483

### SUMMARY OF INVENTION

### Technical Problem

Patent Literature 1 discloses that congestion in an airport is reduced by adjusting the schedules of transportation facilities. However, since the transportation facilities and the airport are run by different operating companies, adjusting the schedules of the transportation facilities due to the situation of the airport alone is not practical. Patent Literature 1 also discloses that mileage is offered to users who arrive early at the airport, but the congestion is not mitigated if mileage is offered to users who have intended to arrive early, and the mileage is given meaninglessly. Although Patent Literature 1 discloses that service staff and operating facilities are adjusted, the adjustment is limited, and the congestion cannot be mitigated if users arrive at the airport at a pace exceeding the limit.

In Patent Literature 2, by distributing privilege information depending on a staying time in an airport, it is possible to guide users to souvenir shops or restaurants. However, Patent Literature 2 does not consider congestion at a security checkpoint or the like. In Patent Literature 2, although, for example, the security checkpoint is not currently congested but is expected to be congested later, privilege information available in restaurants can be distributed to users who arrive early at the airport. In this case, although the users could pass through the security checkpoint without waiting if the users passed through the security checkpoint immediately after arriving at the airport, the users head for the security checkpoint after meals, and which can cause further congestion at the security checkpoint.

An object of the present disclosure is, in view of the above situation, to provide a privilege issuing apparatus, a method, and a computer-readable medium that are capable of mitigating congestion at a security checkpoint in an airport.

### Solution to Problem

In order to achieve the above-described object, the present disclosure provides a privilege issuing apparatus including a scheduled boarding time acquiring means for acquiring a scheduled boarding time of an airport user, a security checkpoint arrival time calculating means for calculating, based on the scheduled boarding time, a security checkpoint arrival time at which the airport user arrives at a security checkpoint, a security checkpoint congestion predicting means for acquiring a time series prediction of congestion at the security checkpoint, a privilege determining means for determining, based on the security checkpoint arrival time and the time series prediction of congestion, privilege information to be issued to the airport user and a validity period for which the privilege information is valid, and a privilege issuing means for issuing, to the airport user, the privilege information determined by the privilege determining means.

The present disclosure also provides a privilege issuing method including acquiring a scheduled boarding time of an airport user, calculating, based on the scheduled boarding time, a security checkpoint arrival time at which the airport user arrives at a security checkpoint, acquiring a time series prediction of congestion at the security checkpoint, determining, based on the security checkpoint arrival time and the time series prediction of congestion, privilege information to be issued to the airport user and a validity period for which the privilege information is valid, and issuing the determined privilege information to the airport user.

The present disclosure further provides a non-transitory computer-readable medium storing a program causing a computer to execute processing of acquiring a scheduled boarding time of an airport user, calculating, based on the scheduled boarding time, a security checkpoint arrival time at which the airport user arrives at a security checkpoint, acquiring a time series prediction of congestion at the security checkpoint, determining, based on the security checkpoint arrival time and the time series prediction of congestion, privilege information to be issued to the airport user and a validity period for which the privilege information is valid, and issuing the determined privilege information to the airport user.

### Advantageous Effects of Invention

A privilege issuing apparatus, a method, and a computer-readable medium according to the present disclosure are expected to mitigate congestion at a security checkpoint in an airport.

### BRIEF DESCRIPTION OF DRAWINGS

FIG. 1 is a block diagram schematically showing a privilege issuing apparatus in the present disclosure.

FIG. 2 is a block diagram showing a privilege issuing system according to a first example embodiment of the present disclosure.

FIG. 3 is a block diagram showing a configuration example of a security checkpoint congestion predicting means.

FIG. 4 is a diagram showing a concrete example of a time series prediction list of a congestion degree at a security checkpoint.

FIG. 5 is a diagram showing a concrete example of a time block list.

FIG. 6 is a block diagram showing a configuration example of a privilege determining means.

FIG. 7A is a diagram schematically showing a privilege condition when a security checkpoint final arrival time is included in a time block having a congestion flag of “1”.

FIG. 7B is a diagram schematically showing a privilege condition when a security checkpoint final arrival time is included in a time block having a congestion flag of “0”.

FIG. 8 is a diagram exemplifying privilege information stored in a privilege list storing means.

FIG. 9 is a flowchart showing an operation procedure of the privilege issuing apparatus.

FIG. 10 is a flowchart showing an operation procedure for privilege determination in step A90.

FIG. 11 is a flowchart showing an operation procedure of a privilege acquiring apparatus.

FIG. 12 is a block diagram showing a privilege issuing system according to a second example embodiment of the present disclosure.

FIG. 13 is a block diagram showing a configuration example of a check-in start time calculating means.

FIG. 14 is a block diagram showing a configuration example of a privilege determining means.

FIG. 15A is a diagram schematically showing a relation between a time block to which a security checkpoint final arrival time belongs and a time block to which a check-in start time belongs.

FIG. 15B is a diagram schematically showing a relation between a time block to which a security checkpoint final arrival time belongs and a time block to which a check-in start time belongs.

FIG. 15C is a diagram schematically showing a relation between a time block to which a security checkpoint final arrival time belongs and a time block to which a check-in start time belongs.

FIG. 16 is a flowchart showing an operation procedure of a privilege issuing apparatus.

FIG. 17 is a flowchart showing an operation procedure for privilege determination in step B120.

FIG. 18 is a block diagram showing a configuration example of a computer device.

FIG. 19 is a diagram schematically showing an airport facility.

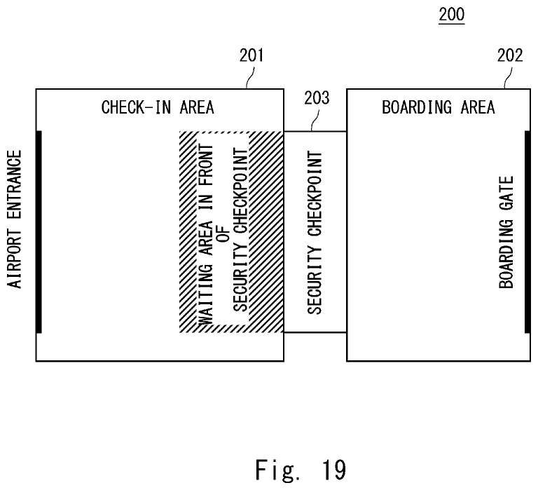

### DESCRIPTION OF EMBODIMENTS

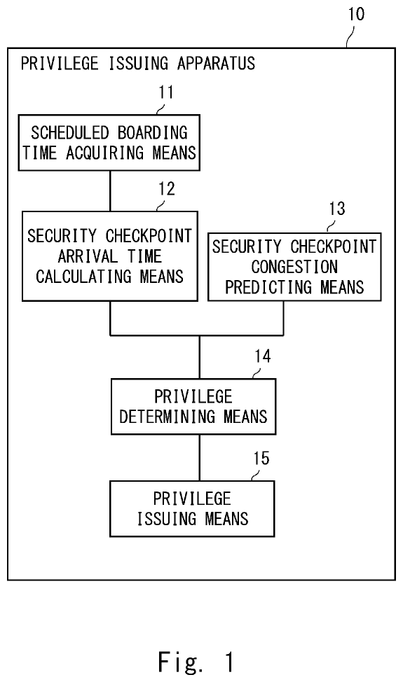

Before example embodiments of the present disclosure are described, an outline of the present disclosure is described. FIG. 1 schematically shows a privilege issuing apparatus in the present disclosure. A privilege issuing apparatus 10 includes a scheduled boarding time acquiring means 11, a security checkpoint arrival time calculating means 12, a security checkpoint congestion predicting means 13, a privilege determining means 14, and a privilege issuing means 15.

The scheduled boarding time acquiring means 11 acquires a scheduled boarding time of an airport user. The security checkpoint arrival time calculating means 12 calculates, based on the scheduled boarding time, a security checkpoint arrival time at which the airport user arrives at a security checkpoint. The security checkpoint congestion predicting means 13 acquires a time series prediction of congestion at the security checkpoint. The privilege determining means 14 determines, based on the security checkpoint arrival time and the time series prediction of congestion at the security checkpoint, privilege information to be issued to the airport user and its validity period. The privilege determining means 14 determines, for example, to issue privilege information available in an area where the airport user can stop at before the airport user passes through the security checkpoint when the security checkpoint is congested in the validity period. Alternatively, the privilege determining means 14 determines to issue privilege information available in an area where the airport user can stop at after the airport user passes through the security checkpoint when the security checkpoint is not congested in the validity period. The privilege issuing means 15 issues, to the airport user, the privilege information determined by the privilege determining means 14.

In the present disclosure, privilege information is issued based on congestion at a security checkpoint and a time at which an airport user arrives at the security checkpoint. In the present disclosure, if congestion at the security checkpoint is predicted at the time at which the airport user arrives at the security checkpoint, privilege information available in an area where the airport user can stop at before the user passes through the security checkpoint may be issued. In this case, if the airport user remains in the area where the airport user can stop at before passing through the security checkpoint to use the privilege information, it is possible to mitigate the congestion at the security checkpoint at the time at which the airport user is supposed to arrive at the security checkpoint. In addition, in the present disclosure, if no congestion at the security checkpoint is predicted at the time at which the airport user arrives at the security checkpoint, privilege information available in an area where the airport user can stop at after the user passes through the security checkpoint may be issued. In this case, if the airport user moves early to the area after passing through the security checkpoint to use the privilege information, it is possible to mitigate the congestion at the security checkpoint at the time at which the airport user is supposed to arrive at the security checkpoint. In this manner, in the present disclosure, by issuing privilege information based on congestion at a security checkpoint and an arrival time at the security checkpoint, it is possible to guide an airport user to a location in which privilege information is available and to mitigate the congestion at the security checkpoint.

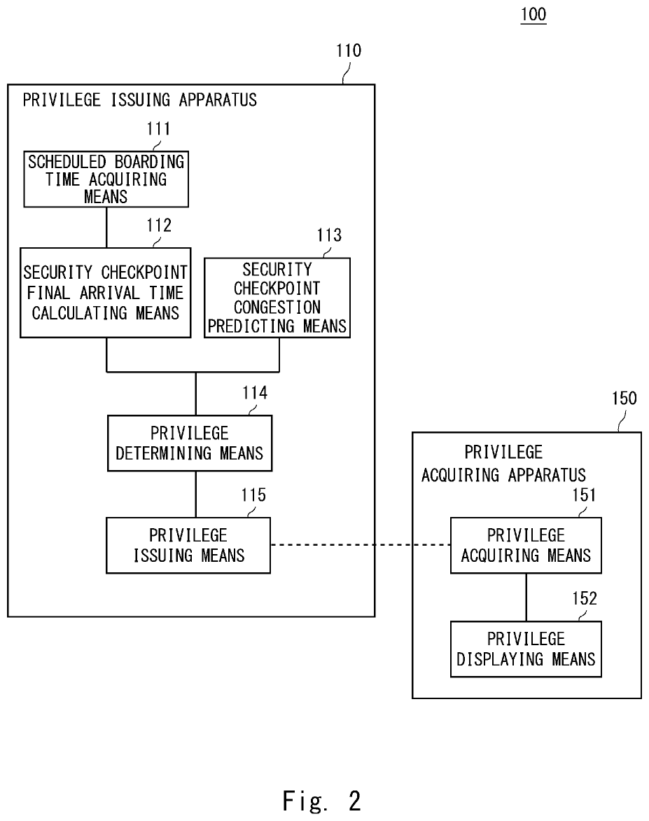

Hereinafter, example embodiments of the present disclosure are described in detail with reference to the drawings. FIG. 2 shows a privilege issuing system according to a first example embodiment of the present disclosure. A privilege issuing system 100 includes a privilege issuing apparatus 110 and a privilege acquiring apparatus 150. The privilege issuing apparatus 110 and the privilege acquiring apparatus 150 are communicably connected to each other by, for example, a communication means, such as a wireless communication means.

The privilege issuing apparatus 110 includes a scheduled boarding time acquiring means 111, a security checkpoint final arrival time calculating means 112, a security checkpoint congestion predicting means 113, a privilege determining means 114, and a privilege issuing means 115. The privilege issuing apparatus 110 corresponds to the privilege issuing apparatus 10 in FIG. 1. The scheduled boarding time acquiring means 111, the security checkpoint final arrival time calculating means 112, the security checkpoint congestion predicting means 113, the privilege determining means 114, and the privilege issuing means 115 correspond to the scheduled boarding time acquiring means 11, the security checkpoint arrival time calculating means 12, the security checkpoint congestion predicting means 13, the privilege determining means 14, and the privilege issuing means 15 in FIG. 1, respectively.

The scheduled boarding time acquiring means 111 acquires a scheduled boarding time of an airport user (user) scheduled to board an aircraft. The scheduled boarding time acquiring means 111 refers to, for example, a flight master storing flight schedules of aircrafts to acquire the scheduled boarding time based on the flight number of the aircraft that the user is scheduled to board. It is assumed that the user has performed user registration to the privilege issuing apparatus 110. The scheduled boarding time acquiring means 111 specifies users scheduled to board aircrafts on the day from, for example, registered users to acquire the scheduled boarding time of each specified user. Alternatively, a user may actively input the flight number of the boarding aircraft, air ticket information, and the like, and the scheduled boarding time acquiring means 111 may acquire the scheduled boarding time if the user inputs the flight number and the like.

The security checkpoint final arrival time calculating means 112 calculates a security checkpoint arrival time at which the user arrives at the security checkpoint. In the present example embodiment, the security checkpoint final arrival time calculating means 112 particularly calculates (acquires) a security checkpoint final arrival time indicating a final time at which the user is required to arrive at the security checkpoint. The security checkpoint final arrival time calculating means 112 calculates, as a security check final arrival time, a time obtained by subtracting a predetermined required time from the scheduled boarding time acquired by the scheduled boarding time acquiring means 111. Here, the “required time” is, for example, a time obtained by adding some margin to a minimum required time for the user to arrive at the security checkpoint and board the aircraft. In addition, the “minimum required time” is a total time required for a user to arrive in front of the security checkpoint, take security check procedures, enter the boarding area, and move from the entrance of the boarding area to the boarding gate. In the case of an international flight, a time for emigration control procedures is added to the total time. The required time is assumed to not include a waiting time in front of the security checkpoint. The required time may be calculated every time depending on the distance to the boarding gate for the boarding flight or the like. Alternatively, the required time may be a predetermined constant value given by a system administrator.

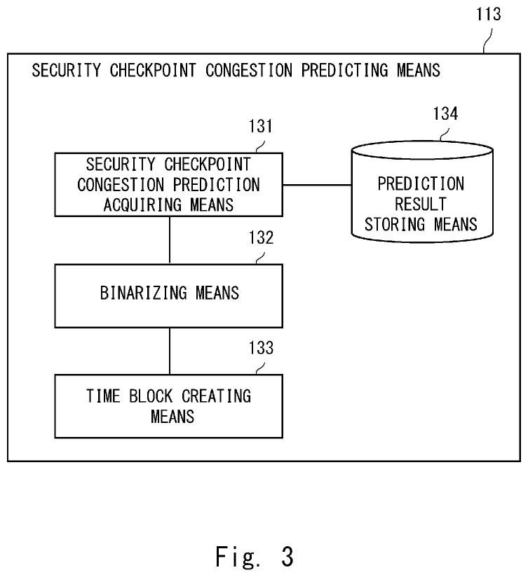

The security checkpoint congestion predicting means 113 predicts congestion in a waiting area in front of the security checkpoint (hereinafter, simply referred to as a security checkpoint front area). FIG. 3 shows a configuration example of the security checkpoint congestion predicting means 113. The security checkpoint congestion predicting means 113 includes a security checkpoint congestion prediction acquiring means 131, a binarizing means 132, and a time block creating means 133. The security checkpoint congestion prediction acquiring means 131 acquires a time series prediction list of the congestion degree in the security checkpoint front area. The security checkpoint congestion prediction acquiring means 131 acquires the time series prediction list from, for example, a prediction result storing means 134 for storing a prediction result of the congestion degree in the security checkpoint front area. A congestion predicting means, which is not shown, predicts the congestion degree in the security checkpoint front area by any method and stores the prediction result in the prediction result storing means 134. The scale of the congestion degree may be represented by, for example, an arrival rate λ [users/time] of users arriving at the security checkpoint front area or a waiting time in the security checkpoint front area.

The binarizing means 132 compares the congestion degree at each time in the time series prediction list of the congestion degree acquired by the security checkpoint congestion prediction acquiring means 131 with a threshold to binarize the congestion degree. In the following, when the congestion degree in the security checkpoint front area is equal to or greater than the threshold or exceeds the threshold, that state is referred to as “congestion”. The threshold is given as a constant in advance by a system administrator. The constant may be a fixed value that does not depend on time or a constant that changes depending on time. For example, the threshold for a time period with heavy congestion may be set to a large value, and the threshold for a time period with mild congestion may be set to a small value. In the following, a binarized congestion degree is also referred to as a “congestion flag”. The value of a congestion flag is, for example, “1” when the congestion degree in the security checkpoint front area is equal to or greater than the threshold and “0” when the congestion degree is less than the threshold.

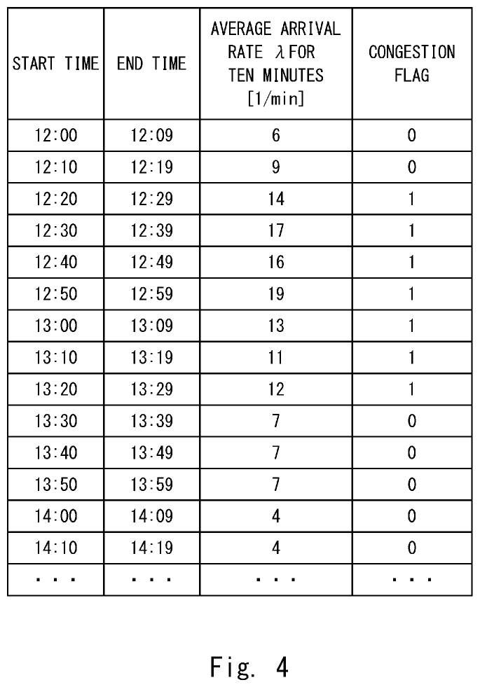

FIG. 4 shows a concrete example of the time series prediction list of the congestion degree in the security checkpoint front area. The congestion predicting means divides time by, for example, a certain length to predict the congestion degree for each divided time. In the example in FIG. 4, the congestion predicting means predicts the congestion degree every ten minutes. The congestion predicting means outputs, for example, an average arrival rate λ as the congestion degree at each time. The security checkpoint congestion prediction acquiring means 131 acquires the average arrival rate λ in each time period. The binarizing means 132 compares the average arrival rate λ for each time period with a threshold to create a congestion flag. The binarizing means 132 uses, for example, a threshold of “10 users/minute” to create a congestion flag of “1” for a time period in which the average arrival rate λ is equal to or greater than the threshold and create a congestion flag of “0” for a time period in which the average arrival rate λ is less than the threshold. Note that, the method used by the congestion predicting means to predict the congestion in the security checkpoint front area is not particularly limited. The congestion predicting means may predict the congestion degree in the security checkpoint front area by, for example, analyzing the actual value of the average arrival rate λ at the security checkpoint in time series.

Returning to FIG. 3, the time block creating means 133 newly defines, based on the value of the congestion flag, a time for which the congestion flag continues as one time block to create a list of time blocks. The time block creating means 133 defines, as one time block, a time from the start time of the time period in which the congestion flag changes from “1” to “0” to the end time of the time period immediately before the time period in which the congestion flag changes from “0” to “1”. The time block creating means 133 further defines, as one time block, a time from the start time of the time period in which the congestion flag changes from “0” to “1” to the end time of the time period immediately before the time period in which the congestion flag changes from “1” to “0”. The time block creating means 133 outputs a list (time block list) including the start time and the end time of each time block and the congestion flags as the prediction result of congestion in the security checkpoint front area.

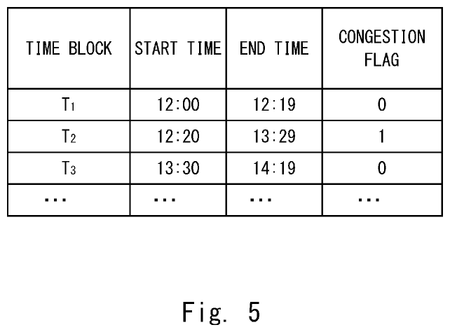

FIG. 5 shows a concrete example of the time block list. For example, in the time series list of the congestion degrees shown in FIG. 4, the congestion flag of the time period having the start time of 12:00 is “0”, and the congestion flag changes to “1” in the time period having the start time of 12:20. In this case, the time block creating means 133 defines the time from 12:00 to 12:19 as one time block T₁ and associates the start time and the end time of the time block T₁ with the congestion flag of “0” to store it in the list. The congestion flag further changes to “0” in the time period having the start time of 13:30. In this case, the time block creating means 133 defines the time from 12:20 to 13:29 as one time block T₂ and associates the start time and the end time of the time block T₂ with the congestion flag of “1” to store it in the list. The congestion flag is binarized, and a time block (first time block) having the congestion flag of “1” and a time block (second time block) having the congestion flag of “0” are alternately repeated in the time block list. The length of each time block can be changed depending on the continuity of the congestion flag.

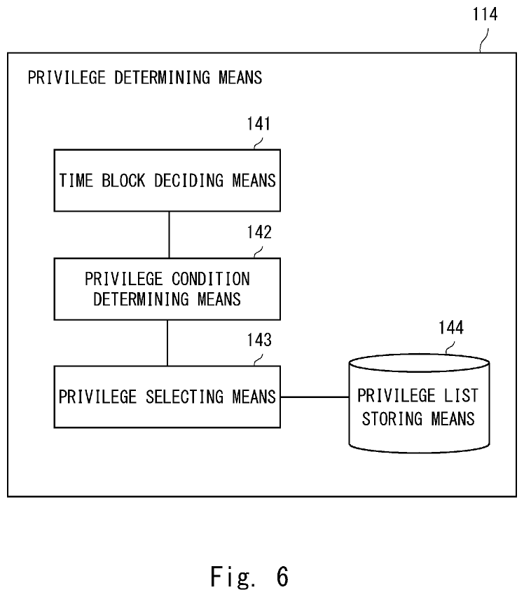

The privilege determining means 114 determines privilege information to be distributed to the user based on the security checkpoint final arrival time calculated by the security checkpoint final arrival time calculating means 112 and the prediction result of the congestion in the security checkpoint front area predicted by the security checkpoint congestion predicting means 113. FIG. 6 shows a configuration example of the privilege determining means 114. The privilege determining means 114 includes a time block deciding means 141, a privilege condition determining means 142, and a privilege selecting means 143. The time block deciding means 141 receives the security checkpoint final arrival time from the security checkpoint final arrival time calculating means 112 and the time block list from the time block creating means 133 (see FIG. 3) of the security checkpoint congestion predicting means 113. The time block deciding means 141 specifies which time block in the time block list the security checkpoint final arrival time belongs to.

The privilege condition determining means 142 determined, depending on the congestion flag of the time block to which the security checkpoint final arrival time belongs, a condition of the privilege information (privilege condition). The privilege condition includes a time (validity period) for which the privilege information is valid and a location in which the privilege information is available.

The privilege condition determining means 142 refers to the time block list to acquire the start time and the end time of the time block one block ahead of the time block to which the security checkpoint final arrival time belongs and the congestion flag of the time block. The privilege condition determining means 142 determines, based on the start time and the end time of the time block one block ahead, the start time and the end time of the validity period for the privilege information.

The privilege condition determining means 142 further determines, depending on the congestion flag of the time block one block ahead, the location in which the privilege information is available. The privilege condition determining means 142 determines, when the congestion flag of the time block one block ahead is “1”, an area where the airport user can stop at before the user passes through the security checkpoint, for example, the check-in area as the location in which the privilege information is available. The privilege condition determining means 142 determines, when the congestion flag of the time block one block ahead is “0”, an area where the airport user can stop at after the user passes through the security checkpoint, for example, the boarding area as the location in which the privilege information is available. In other words, the privilege condition determining means 142 determines, depending on whether the security checkpoint is congested in the time block one block ahead, that the privilege information to be distributed is available in the check-in area or that the privilege information to be distributed is available in the boarding area.

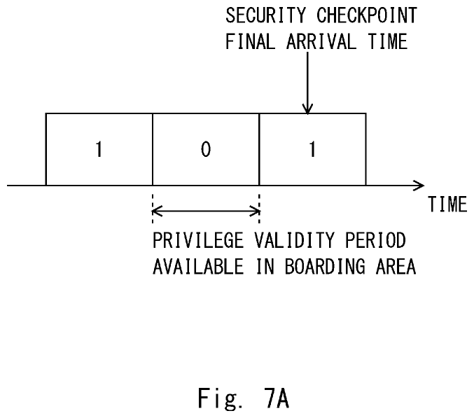

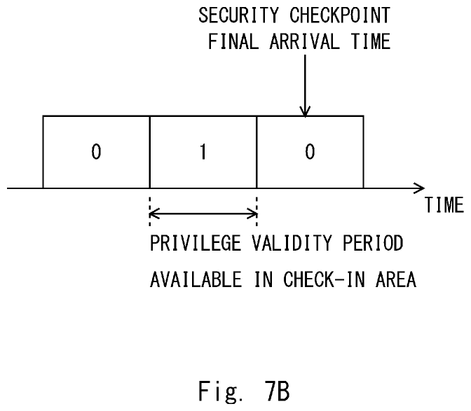

FIG. 7A shows a privilege condition when the time block having the congestion flag of “1” includes the security checkpoint final arrival time. FIG. 7B shows a privilege condition when the time block having the congestion flag of “0” includes the security checkpoint final arrival time. As shown in FIG. 7A, the case where the security checkpoint final arrival time is included in the time block in which the security checkpoint is congested is considered. In this case, the security checkpoint is not congested in the block one block ahead of the time block to which the security checkpoint final arrival time belongs, and the congestion in the time block including the security checkpoint final arrival time could be mitigated if a user passed through the security checkpoint in the time block one block ahead. For this reason, the privilege condition determining means 142 determines, as the privilege condition, a condition that the validity period is from the start time to the end time of the time block one block ahead and that the location in which the privilege information is available is the boarding area after passing through the security checkpoint. In this case, if the user moves to the boarding area in the validity period of the privilege condition, the user can use the distributed privilege information. In this manner, it is possible to guide the user to the boarding area where the airport user can stop at before the security checkpoint is congested and to mitigate congestion at the security checkpoint.

In contrast to the above, as shown in FIG. 7B, the case where the security checkpoint final arrival time is included in the time block in which the security checkpoint is not congested is considered. In this case, the security checkpoint is congested in the time block one block ahead of the time block to which the security checkpoint final arrival time belongs. In this case, if a user who has arrived early at the airport passes through the security checkpoint in the time block one block ahead of the time block including the security checkpoint final arrival time, the security checkpoint is further congested in the time block one block ahead. For this reason, the privilege condition determining means 142 determines, as the privilege condition, a condition that the validity period is from the start time to the end time of the time block one block ahead and that the location in which the privilege information is available is the check-in area before passing through the security checkpoint. In this case, if the user remains in the check-in area in the validity period of the privilege condition, the user can use the distributed privilege information. In this manner, it is possible to guide the user not to pass through the security checkpoint at the time when the security checkpoint is congested and to mitigate congestion at the security checkpoint. Note that, in the case of FIG. 7B, it is not necessary to issue the privilege information available in the boarding area for the time block to which the security checkpoint final arrival time belongs. This is because that a user who arrives at the security checkpoint in this time block definitely passes through the security checkpoint since the scheduled boarding time is approaching, that is, that such guiding is not necessary.

The privilege selecting means 143 determines, in accordance with the privilege condition determined by the privilege condition determining means 142, privilege information to be distributed to a user. A privilege list storing means 144 stores the privilege information to be distributed to the user. The privilege selecting means 143 determines, depending on, for example, the location in which the privilege is available determined as the privilege condition, which privilege information is to be distributed among privilege information stored in the privilege list storing means 144.

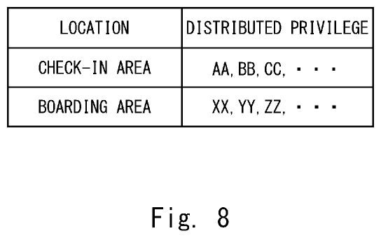

FIG. 8 shows an example of the privilege information stored in the privilege list storing means 144. The privilege list storing means 144 stores the privilege information to be distributed to the user in association with the location in which the privilege information is to be used. In the example in FIG. 8, the privilege list storing means 144 stores, in association with the location “check-in area”, a list (privilege list) of privilege information available at stores and the like in the check-in area, such as privilege information “AA”, “BB”, and “CC”. The privilege selecting means 143 determines, when the location, in which the privilege information is available, included in the privilege condition is the “check-in area”, privilege information to be distributed from among the privilege information “AA”, “BB”, “CC”, and the like stored in association with the “check-in area”.

The privilege list storing means 144 further stores, in association with the location “boarding area”, a list of privilege information available at stores and the like in the boarding area, such as privilege information “XX”, “YY”, and “ZZ”. The privilege selecting means 143 determines, when the location, in which the privilege information is available, included in the privilege condition is the “boarding area”, privilege information to be distributed from among the privilege information “XX”, “YY”, “ZZ”, and the like stored in association with the “boarding area”.

Returning to FIG. 2, the privilege issuing means 115 transmits, to the privilege acquiring apparatus 150, the privilege information determined by the privilege determining means 114 as privilege information available in the validity period determined as the privilege condition. The privilege issuing means 115 transmits the privilege information to the privilege acquiring apparatus 150 with, for example, an electronic mail. The privilege information may be, for example, described in the body of the electronic mail as text or in an image file attached to the electronic mail. Alternatively, the privilege issuing means 115 may transmit the privilege information to an application installed in the privilege acquiring apparatus 150.

The privilege acquiring apparatus 150 receives, via wireless communication, the privilege information from the privilege issuing apparatus 110. The privilege acquiring apparatus 150 is configured as, for example, a terminal device possessed by a user, such as a smartphone, a tablet, or a mobile phone. Alternatively, the privilege acquiring apparatus 150 may be a terminal device installed in the airport and available to the user, such as a KIOSK terminal.

The privilege acquiring apparatus 150 includes a privilege acquiring means 151 and a privilege displaying means 152. The privilege acquiring means 151 receives the privilege information transmitted by the privilege issuing apparatus 110. The privilege acquiring means 151 includes, for example, software to receive an electronic mail and receives the privilege information distributed with an electronic mail. Alternatively, the privilege acquiring means 151 includes an application to receive the privilege information from the privilege issuing apparatus 110 and receives the privilege information using the application. When the privilege acquiring apparatus 150 is configured as a terminal device, such as a KIOSK terminal, the user may operate the KIOSK terminal to actively acquire the privilege information. The privilege displaying means 152 displays the privilege information received by the privilege acquiring means 151 on a screen of a display device or the like.

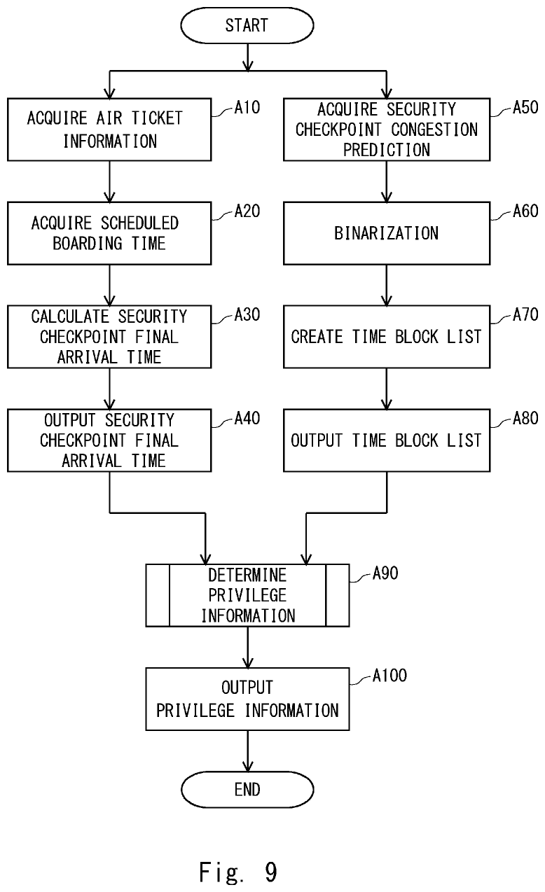

Next, operation procedures are described. FIG. 9 shows an operation procedure (a privilege issuing method) of the privilege issuing apparatus 110. The scheduled boarding time acquiring means 111 acquires air ticket information about the aircraft that a user is scheduled to board (step A10). The air ticket information is input from, for example, an unshown input device. The scheduled boarding time acquiring means 111 compares the input air ticket information with the flight master to acquire a scheduled boarding time of the boarding flight (step A20).

The security checkpoint final arrival time calculating means 112 acquires the scheduled boarding time from the scheduled boarding time acquiring means 111. The security checkpoint final arrival time calculating means 112 calculates, based on the acquired scheduled boarding time, a security checkpoint final arrival time (step A30). The security checkpoint final arrival time calculating means 112 subtracts a required time predetermined by a system administrator from the scheduled boarding time to set the result as the security checkpoint final arrival time in step A30. The security checkpoint final arrival time calculating means 112 outputs the calculated security checkpoint final arrival time to the privilege determining means 114 (step A40).

The security checkpoint congestion prediction acquiring means 131 (see FIG. 3) acquires a security checkpoint arrival rate, which is a prediction result of the congestion degree at the security checkpoint, from the prediction result storing means 134 (step A50) and outputs a time series prediction list of the security checkpoint arrival rate to the binarizing means 132. The binarizing means 132 binarizes, based on a predetermined threshold, the value of the security checkpoint arrival rate in each time period (step A60) and creates a list of the congestion flag of each time. The time block creating means 133 acquires the list of a congestion flag from the binarizing means 132, defines a time for which the congestion flag continues as one time block, and creates a time block list (step A70). The time block creating means 133 outputs the created time block list to the privilege determining means 114 (step A80).

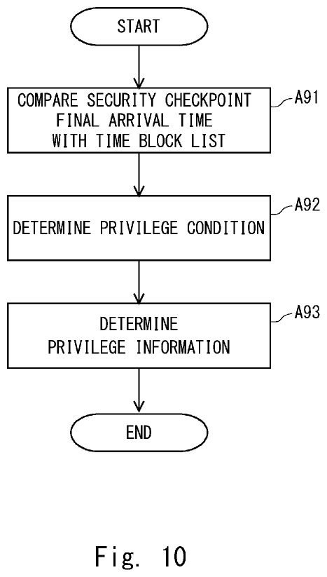

The privilege determining means 114 determines, based on the security checkpoint final arrival time output in step A40 and the time block list output in step A80, privilege to be distributed to the user (step A90). FIG. 10 shows an operation procedure for privilege determination in step A90. The time block deciding means 141 (see FIG. 5) of the privilege determining means 114 compares the security checkpoint final arrival time with the time block list to check which time block includes the security checkpoint final arrival time (step A91).

The privilege condition determining means 142 determines a privilege condition based on the start time and the end time of the time block one block ahead of the time block including the security checkpoint final arrival time and the congestion flag of the time block (step A92). In step A92, the privilege condition determining means 142 determines that the validity period of the privilege information is from the start time to end time of the time block one block ahead. The privilege condition determining means 142 further determines, when the congestion flag of the time block one block ahead is “1”, that the location in which the privilege information is available is the boarding area. On the other hand, the privilege condition determining means 142 determines, when the one block ahead congestion flag is “0”, that the location in which the privilege information is available is the check-in area.

The privilege selecting means 143 refers to the privilege list storing means 144 to determine (select), based on the location, in which the privilege information is available, of the privilege condition determined in step A92, privilege information to be distributed to the user (step A93). The privilege selecting means 143 selects, when, for example, the location in which the privilege information is available is the “check-in area”, one or more pieces of privilege information from the privilege information stored in association with the “check-in area” by referring to the privilege list shown in FIG. 8. The privilege selecting means 143 selects, when, for example, the location in which the privilege information is available is the “boarding area”, one or more pieces of privilege information from the privilege information stored in association with the “boarding area” by referring to the privilege list shown in FIG. 8.

Returning to FIG. 9, the privilege issuing means 115 transmits the privilege information determined by the privilege determining means 114 to the privilege acquiring apparatus 150 (step A100). The privilege issuing means 115 transmits, in step A100, the one or more pieces of privilege information valid in the validity period of the privilege condition determined in step A90 to the privilege acquiring apparatus 150.

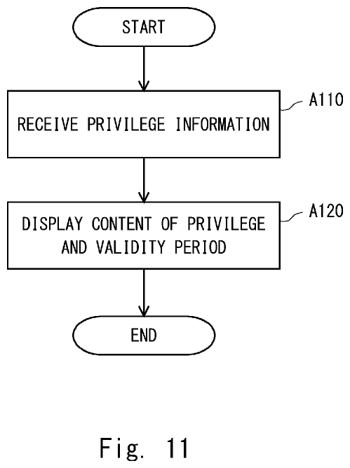

FIG. 11 shows an operation procedure of the privilege acquiring apparatus 150. The privilege acquiring means 151 receives the privilege information transmitted from the privilege issuing means 115 of the privilege issuing apparatus 110 (step A110). The privilege displaying means 152 displays the content of the privilege information and its validity period (the start time and the end time) (step A120). The privilege displaying means 152 displays, in step A120, the privilege information and its validity period using, for example, an application installed in advance in an information terminal, such as a smartphone. The privilege displaying means 152 may display the privilege information and its validity period using a Web browser.

In the present example embodiment, the validity period of the privilege information and which area the privilege information is available are determined based on the congestion prediction at the security checkpoint and the scheduled boarding time of each user. By determining privilege information in this manner, it is possible to motivate each user to change the timing at which the user passes through the security checkpoint. In this manner, it is possible to control the number of users who arrive at the security checkpoint per unit time to a certain extent and to mitigate congestion at the security checkpoint without changing the service providing time at the security checkpoint (i.e. the processing capability of the security checkpoint).

Here, a waiting time for a security check in an airport is included in Skytrax rating items, which are indexes for measuring comfort of airports around the world. A long waiting time for a security check leads to low customer satisfaction (CS) and to a lowered airport rating. Skytrax rating is frequently used to invite airlines, and a high rating causes increased customers and indirectly causes increased sales of the airport itself. In the present example embodiment, by mitigating congestion at the security checkpoint, it is possible to improve the airport rating.

In addition, in the present example embodiment, depending on whether the security checkpoint is congested in the time block including the security checkpoint final arrival time of each user, privilege information available in a desired location to which each user is guided in the time block one block ahead is distributed. In the present example embodiment, when the security checkpoint is congested in the time block including the security checkpoint final arrival time, privilege information available in the boarding area in the time block one block ahead is distributed. Alternatively, when the security checkpoint is not congested in the time block including the security checkpoint final arrival time, privilege information available in the check-in area in the time block one block ahead is distributed. In the present example embodiment, privilege information available in a desired location to which users are guided is distributed to desired users to be guided. In this manner, compared to the case where the same privilege information is distributed to all the users, it is possible to reduce the issuance of meaningless privilege information and to efficiently guide users.

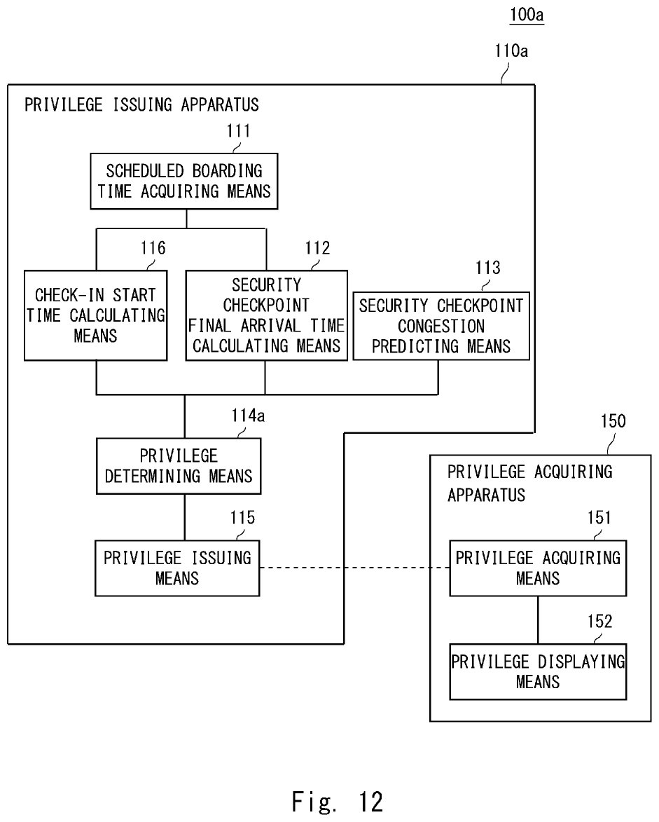

Next, a second example embodiment of the present disclosure is described. FIG. 12 shows a privilege issuing system according to the second example embodiment of the present disclosure. A privilege issuing system 100a includes a privilege issuing apparatus 110a and a privilege acquiring apparatus 150. In the present example embodiment, the privilege issuing apparatus 110a includes a check-in start time calculating means 116 in addition to the configuration of the privilege issuing apparatus 110 shown in FIG. 2 and described in the first example embodiment. The check-in start time calculating means 116 acquires the check-in start time of the aircraft that a user is scheduled to board. In the present example embodiment, a privilege determining means 114a determines privilege condition based on the check-in start time, the security checkpoint final arrival time, and the prediction result of the congestion degree at the security checkpoint.

The other things may be similar to those in the first example embodiment.

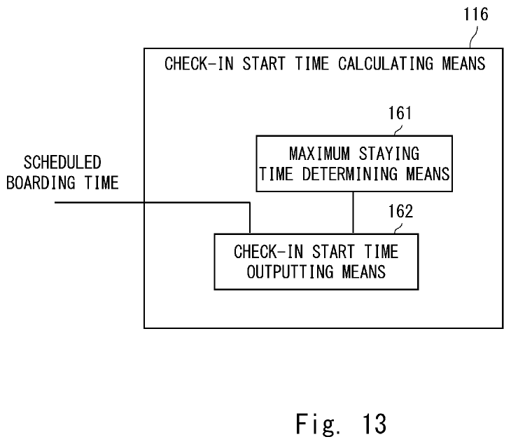

FIG. 13 shows a configuration example of the check-in start time calculating means 116. The check-in start time calculating means 116 includes a maximum staying time determining means 161 and a check-in start time outputting means 162. The maximum staying time determining means 161 determines the maximum staying time of the user. The maximum staying time indicates, for example, a maximum time period from a time at which the user arrives at the airport and checks in using a terminal in the airport to a time at which the user boards on an aircraft. The maximum staying time determining means 161 refers to, for example, the flight master to determine the maximum staying time depending on which airline operator's aircraft that the user is to board. For example, a check in available time for a domestic flight of an airline company is set to two hours before the scheduled boarding time. In this case, the maximum staying time determining means 161 determines two hours as the maximum staying time. The maximum staying time can be changed depending on the airline operator or on whether the boarding flight is a domestic flight or an international flight.

Note that, the user can use online check-in to check in regardless of whether the user has arrived at the airport. In this case, the check-in time has no practical restriction. In such a case, the maximum staying time determining means 161 may determine, as the maximum staying time, the longest time among times preset by a system designer according to operation and for which airport users can stay in the airport.

The check-in start time outputting means 162 receives the scheduled boarding time of the user from the scheduled boarding time acquiring means 111. The check-in start time outputting means 162 calculates, as the check-in start time, the time obtained by subtracting the maximum staying time determined by the maximum staying time determining means 161 from the scheduled boarding time. Here, the check-in start time corresponds to the staying start time of the user in the airport, and the check-in start time calculating means 116 corresponds to a staying start time calculating means. The check-in start time outputting means 162 outputs the calculated check-in start time to the privilege determining means 114a.

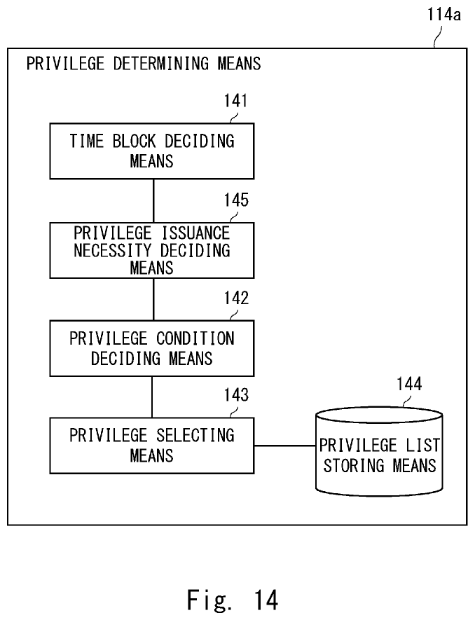

FIG. 14 shows a configuration example of the privilege determining means 114a. The privilege determining means 114a includes a privilege issuance necessity deciding means 145 in addition to the configuration of the privilege determining means 114 shown in FIG. 6 and described in the first example embodiment. In the present example embodiment, the time block deciding means 141 further receives the check-in start time from the check-in start time calculating means 116. The time block deciding means 141 decides, in addition to the determination as to which time block in the time block list the security checkpoint final arrival time belongs to, which time block in the time block list the check-in start time belongs to. The privilege issuance necessity deciding means 145 decides whether the issuance of privilege is necessary or not, depending on the relation between the time block to which the security checkpoint final arrival time belongs and the time block to which the check-in start time belongs.

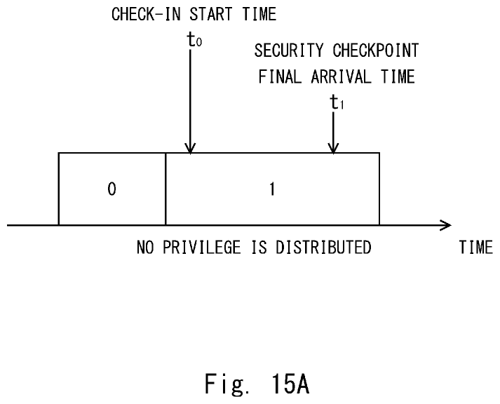

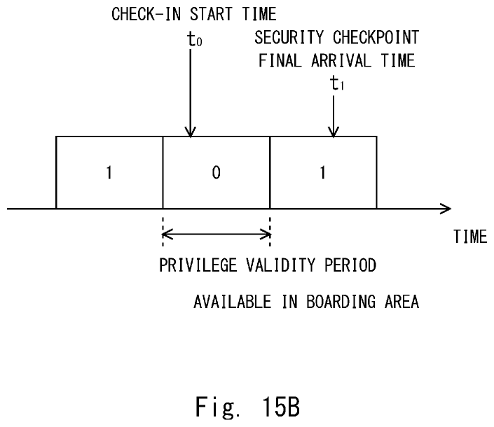

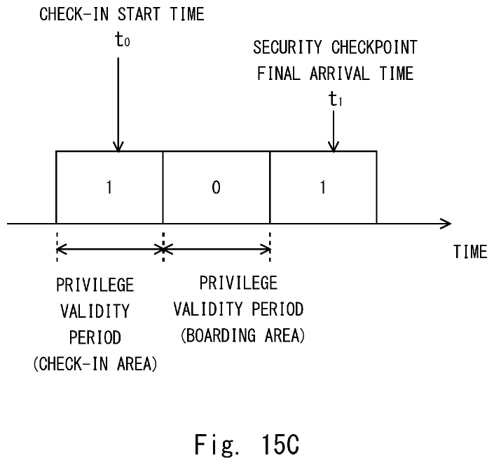

FIGS. 15A to 15C show the relation between the time block to which the security checkpoint final arrival time belongs and the time block to which the check-in start time belongs. FIG. 15A shows the case where a security checkpoint final arrival time (time t₁) and a check-in start time (time t₀) belong to the same time block and the congestion flag of the time block is “1”. In this case, since the security checkpoint is continuously congested while the user stays in the airport, it is pointless to control the timing for the user to pass through security checkpoint by issuing privilege information. In the case where the congestion flag is “0”, since the security checkpoint is not continuously congested while the user stays in the airport, it is pointless to control the timing for the user to pass through the security checkpoint by issuing privilege information. Accordingly, when the security checkpoint final arrival time ti and the check-in start time to belong to the same time block, the privilege issuance necessity deciding means 145 decides not to issue privilege information.

FIG. 15B shows the case where the time block to which the check-in start time t₀ belongs is the time block one block ahead of the time block to which the security checkpoint final arrival time t₁ belongs and the congestion flag of the time block to which the security checkpoint final arrival time (time t₁) belongs is “1”. In this case, it is desired to guide the user to the boarding area in the time block to which the check-in start time to belongs. Alternatively, when the congestion flag of the time block to which the security checkpoint final arrival time ti belongs is “0”, it is desired to guide the user to remain in the check-in area in the time block to which the check-in start time to belongs. Accordingly, when the time block to which the check-in start time to belongs is the time block one block ahead of the time block to which the security checkpoint final arrival time t₁ belongs, the privilege issuance necessity deciding means 145 decides to issue privilege information for the time block one block ahead.

FIG. 15C shows the case where the time block to which the check-in start time to belongs is the time block two blocks ahead of the time block to which the security checkpoint final arrival time t₁ belongs and the congestion flag of the time block to which the security checkpoint final arrival time t₁ belongs is “1”. In this case, since the security checkpoint is congested in the time block to which the check-in start time to belongs, it is desired to guide the user to remain in the check-in area. On the other hand, since the security checkpoint is not congested in the time block one block ahead of the time block to which the security checkpoint final arrival time ti belongs, it is desired to guide the user to the boarding area. If the congestion flag of the time block to which the security checkpoint final arrival time t₁ belongs is “0”, the security checkpoint is not congested in the time block to which the check-in start time to belongs, and it is desired to guide the user to the boarding area. In addition, the security checkpoint is congested in the time block one block ahead of the time block to which the security checkpoint final arrival time ti belongs, and it is desired to guide the user to remain in the check-in area. Accordingly, when the time block to which the check-in start time to belongs is a time block two or more blocks ahead of the time block to which the security checkpoint final arrival time ti belongs, the privilege issuance necessity deciding means 145 decides to issue privilege information. At that time, the privilege issuance necessity deciding means 145 decides to issue privilege information for each of time blocks from the time block including the staying start time to to the time block one block ahead of the time block including the security checkpoint final arrival time t₁.

The privilege condition determining means 142 determines a privilege condition when the privilege issuance necessity deciding means 145 decides to issue the privilege information. The privilege condition determining means 142 determines a privilege condition similarly to the first example embodiment when the time block to which the check-in start time belongs is the time block one block ahead of the time block to which the security checkpoint final arrival time belongs. That is, when the congestion flag of the time block to which the security checkpoint final arrival time belongs is “1”, the privilege condition determining means 142 determines, as the privilege condition, a condition that the validity period is from the start time to the end time of the time block one block ahead and that the available location is the “boarding area”. When the congestion flag of the time block to which the security checkpoint final arrival time is “0”, the privilege condition determining means 142 determines, as the privilege condition, a condition that the validity period is from the start time to the end time of the time block one block ahead and that the available location is the “check-in area”.

The privilege condition determining means 142 determines, when the time block to which the check-in start time belongs is a time block two or more blocks ahead of the time block to which the security checkpoint final arrival time belongs, a privilege condition for each of the time blocks two or more blocks ahead. For example, when the time block to which the check-in start time belongs is the time block two blocks ahead of the time block to which the security checkpoint final arrival time belongs, a privilege condition is determined for each of the two time blocks as follows. The privilege condition determining means 142 determines that the validity period for the time block two blocks ahead is from the start time to the end time of the time block two blocks ahead. In addition, the privilege condition determining means 142 determines, when the congestion flag of the time block two blocks ahead is “0”, that the location in which the privilege information is available is the “boarding area”. The privilege condition determining means 142 determines, when the congestion flag of the time block two blocks ahead is “1”, that the location in which the privilege information is available is the “check-in area”. On the other hand, the privilege condition determining means 142 determines that the validity period for the time block one block ahead is from the start time to the end time of the time block one block ahead. The privilege condition determining means 142 determines, when the congestion flag of the time block one block ahead is “1”, that the location in which the privilege information is available is the “check-in area”. The privilege condition determining means 142 determines, when the congestion flag of the time block one block ahead is “0”, that the location in which the privilege information is available is the “boarding area”. The privilege condition determining means 142 does not determine a privilege condition when the privilege issuance necessity deciding means 145 decides not to issue privilege information.

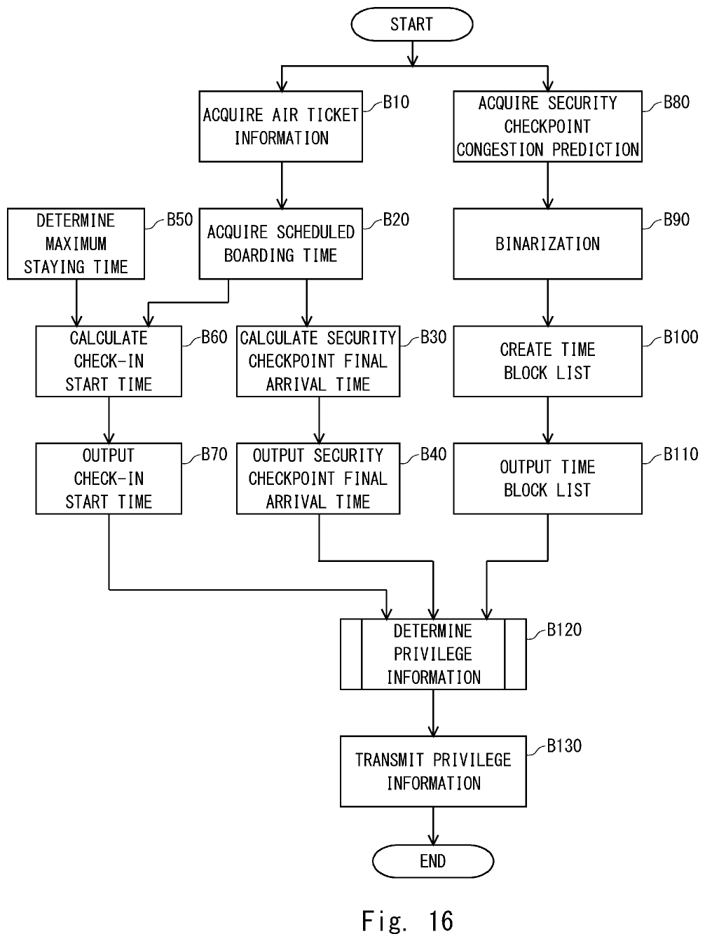

FIG. 16 shows an operation procedure of the privilege issuing apparatus 110a. The scheduled boarding time acquiring means 111 acquires air ticket information about the aircraft that the user is scheduled to board (step B 10). The scheduled boarding time acquiring means 111 compares the input air ticket information with the flight master to acquire the scheduled boarding time of the boarding flight (step B20). The security checkpoint final arrival time calculating means 112 calculates, based on the acquired scheduled boarding time, a security checkpoint final arrival time (step B30). The security checkpoint final arrival time calculating means 112 outputs the calculated security checkpoint final arrival time to the privilege determining means 114 (step B40). The processing from step B10 to step B40 may be similar to that from step A10 to step A40 in FIG. 9.

The maximum staying time determining means 161 (see FIG. 13) determines a maximum staying time (step B50). The check-in start time outputting means 162 acquires, from the scheduled boarding time acquiring means 111, the scheduled boarding time of the user acquired in step B20 and acquires, from the maximum staying time determining means 161, the maximum staying time determined in step B50. The check-in start time outputting means 162 calculates, based on the scheduled boarding time and the maximum staying time, a check-in start time (step B60). The check-in start time outputting means 162 sets, for example, the time obtained by subtracting the maximum staying time from the scheduled boarding time as the check-in start time. The check-in start time outputting means 162 outputs the check-in start time to the privilege determining means 114a (step B70).

The security checkpoint congestion prediction acquiring means 131 (see FIG. 3) acquires a security checkpoint arrival rate, which is a prediction result of the congestion degree at the security checkpoint, from the prediction result storing means 134 (step B80) and outputs a time series prediction list of the security checkpoint arrival rate to the binarizing means 132. The binarizing means 132 binarizes, based on a predetermined threshold, the value of the security checkpoint arrival rate in each time period (step B90) and creates a list of the congestion flag of each time. The time block creating means 133 acquires the list of the congestion flag from the binarizing means 132, defines a time for which the congestion flag continues as one time block, and creates a time block list (step B100). The time block creating means 133 outputs the created time block list to the privilege determining means 114a (step B110). The processing from step B80 to step B110 may be similar to that from step A50 to step A80 in FIG. 9.

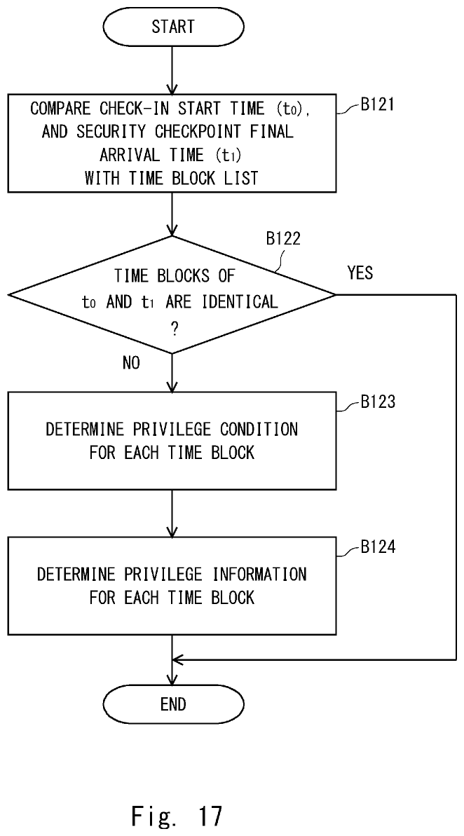

The privilege determining means 114a determines a privilege to be distributed to the user based on the security checkpoint final arrival time output in step B40, the check-in start time output in step B70, and the time block list output in step B110 (step B 120). FIG. 17 shows an operation procedure for the privilege determination in step B120. The time block deciding means 141 (see FIG. 14) of the privilege determining means 114a compares the check-in start time t₀ and the security checkpoint final arrival time t₁ with the time block list. The time block deciding means 141 checks which time block each of the check-in start time to and the security checkpoint final arrival time t₁ is included in (step B121).

The privilege issuance necessity deciding means 145 decides whether the time block to which the check-in start time to belongs is identical to the time block to which the security checkpoint final arrival time ti belongs (step B122). The privilege issuance necessity deciding means 145 decides not to issue privilege information and terminates the processing when the check-in start time to and the security checkpoint final arrival time t₁ belong to the same time block in step B122. The privilege issuance necessity deciding means 145 decides to issue privilege information when the check-in start time to and the security checkpoint final arrival time t₁ belong to different time blocks.

The privilege condition determining means 142 determines, when the issuance of privilege information is decided, a privilege condition for each of time blocks from the time block to which the check-in start time to belongs to the time block one block ahead of the time block to which the security checkpoint final arrival time ti belongs (step B123). The privilege condition determining means 142 determines, for the time block having the congestion flag of “0”, a condition that the validity period is from the start time to the end time of the time block and that the location in which the privilege information is available is the “boarding area” as the privilege condition. The privilege condition determining means 142 determines, for the time block having the congestion flag of “1”, a condition that the validity period is from the start time to the end time of the time block and that the location in which the privilege information is available is the “check-in area” as the privilege condition.

The privilege selecting means 143 refers to the privilege list storing means 144 to determine (select), based on the location, in which the privilege information is available, of the privilege condition determined in step B122, privilege information to be distributed to the user (step B124). The privilege selecting means 143 refers, when the location in which the privilege information is available is, for example, “check-in area”, to the privilege list shown in FIG. 8 to select, from the privilege information stored in association with the “check-in area”, one or more pieces of privilege information. The privilege selecting means 143 refers, when the location in which the privilege information is available is, for example, the “boarding area”, to the privilege list shown in FIG. 8 to select, from the privilege information stored in association with the “boarding area”, one or more pieces of privilege information.

Returning to FIG. 16, the privilege issuing means 115 outputs the privilege information determined by the privilege determining means 114a to the privilege acquiring apparatus 150 (step B130). The privilege issuing means 115 outputs, in step B130, one or more pieces of privilege information available in the validity period of each privilege condition determined in step B120 to the privilege acquiring apparatus 150. The privilege issuing means 115 outputs, when the time block to which the check-in start time to belongs is a time block two or more blocks ahead of the time block to which the security checkpoint final arrival time ti belongs, the privilege information available in each of a plurality of time blocks. The privilege issuing means 115 does not transmit privilege information to the privilege acquiring apparatus 150 when the privilege determining means 114a determines not to issue privilege information.

In the present example embodiment, the check-in start time calculating means 116 calculates a time for the user to start checking in. The privilege issuance necessity deciding means 145 of the privilege determining means 114a decides not to issue privilege information when the time block to which the check-in start time belongs is identical to the block to which the security checkpoint final arrival time belongs. By not issuing privilege information when the privilege issuance necessity deciding means 145 decides not to issue privilege information, it is possible to prevent privilege information that does not contribute to controlling a timing of passing through the security checkpoint from being transmitted. In addition, in the present example embodiment, when the time block to which the check-in start time belongs is a time block two or more blocks ahead of the time block to which the security checkpoint final arrival time belongs, privilege information available in each of a plurality of time blocks is issued. By issuing a plurality of pieces of privilege information, it is possible for the user to select privilege information depending on the user's situation and to improve the efficiency of the guiding.

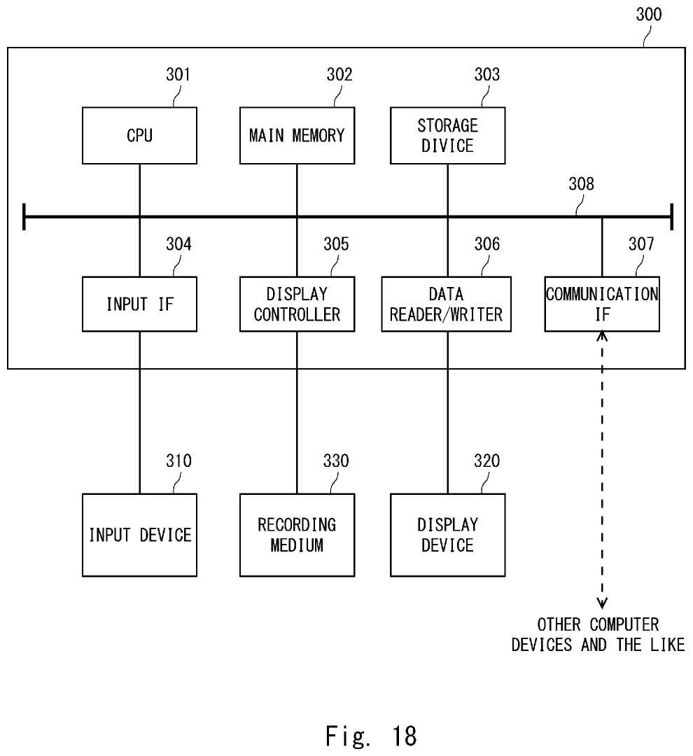

Note that, in each example embodiment, the privilege issuing apparatus 110 and the privilege acquiring apparatus 150 can be implemented by a computer device. FIG. 18 shows a configuration example of the computer device. A computer device 300 includes a central processing unit (CPU) 301, a main memory 302, a storage device 303, an input interface 304, a display controller 305, a data reader/writer 306, and a communication interface 307. In the computer device 300, these elements are connected to each other via a bus 308 in such a manner as to be capable of data communication.

The CPU 301 loads a program (code) stored in the storage device 303 in the main memory 302 and executes the program to perform various calculations. The main memory 302 is typically a volatile storage device, such as a dynamic random access memory (DRAM). The program to function the computer device 300 as the privilege issuing apparatus 110 is provided by, for example, being stored in a computer-readable recording medium 320. The program may be provided through a network, such as the Internet, connected via the communication interface 307.

The program can be stored in various non-transitory computer-readable media and provided to a computer. The non-transitory computer-readable media include various tangible recording media. The non-transitory computer-readable media include, for example, a magnetic recording medium, such as a flexible disc, a magnetic tape, or a hard disk, a magneto-optical recording medium, such as a magneto-optical disc, an optical disc medium, such as a compact disc (CD) or a digital versatile disk (DVD), and a semiconductor memory, such as a mask read only memory (ROM), a programmable ROM (PROM), an erasable PROM (EPROM), a flash ROM, or a random access memory (RAM). Alternatively, the program may be provided to a computer using various transitory computer-readable media. The transitory computer-readable media include, for example, an electrical signal, an optical signal, and an electromagnetic wave. The transitory computer-readable media can provide the program to a computer via wired communication channels, such as an electric wire and an optical fiber, or wireless communication channels.

The storage device 303 is implemented as, for example, a disk device, such as a hard disk drive, or a semiconductor memory, such as a flash memory. The input interface 304 mediates data transmission between the CPU 301 and an input device 310, such as a key board and a mouse. The display controller 305 is connected with a display device 330 and controls display on the display device 330. The data reader/writer 306 mediates data transmission between the CPU 301 and the recording medium 320. The data reader/writer 306 reads the program from, for example, the recording medium 320 and transmits the read program to the CPU 301. The communication interface 307 mediates data transmission between the CPU 301 and other computers.

The example embodiments described above are preferred example embodiments of the present disclosure and do not limit the scope of the present disclosure to the above example embodiments, and can be implemented in a configuration in which various modification is made without departing from the scope of the present disclosure.

For example, a part or all of the above example embodiments can be described as the following Supplementary notes but are not limited to the following.

[Supplementary Note 1]

A privilege issuing apparatus comprising:

a scheduled boarding time acquiring unit configured to acquire a scheduled boarding time of an airport user;

a security checkpoint arrival time calculating unit configured to calculate, based on the scheduled boarding time, a security checkpoint arrival time at which the airport user arrives at a security checkpoint;

a security checkpoint congestion predicting unit configured to acquire a time series prediction of congestion at the security checkpoint;

a privilege determining unit configured to determine, based on the security checkpoint arrival time and the time series prediction of congestion, privilege information to be issued to the airport user and a validity period for which the privilege information is valid; and

a privilege issuing unit configured to issue, to the airport user, the privilege information determined by the privilege determining unit.

[Supplementary Note 2]

The privilege issuing apparatus according to Supplementary note 1, wherein the privilege determining unit determines to issue privilege information available in an area where the airport user can stop at before the airport user passes through the security checkpoint when the security checkpoint is congested in the validity period and determines to issue privilege information available in an area where the airport user can stop at after the airport user passes through the security checkpoint when the security checkpoint is not congested in the validity period.

[Supplementary Note 3]

The privilege issuing apparatus according to Supplementary note 1 or 2, wherein the security checkpoint congestion predicting unit outputs, to the privilege determining unit, information indicating a time period for which the security checkpoint is congested and information indicating a time period for which the security checkpoint is not congested as the time series prediction of congestion.

[Supplementary Note 4]

The privilege issuing apparatus according to any one of Supplementary notes 1 to 3, wherein

the security checkpoint congestion predicting unit comprises:
a security checkpoint congestion predicting unit configured to acquire a prediction result of congestion at the security checkpoint predicted in time series;
a binarizing unit configured to create, based on the prediction result of congestion, a congestion flag indicating whether the security checkpoint is congested; and
a time block list creating unit configured to define, based on the congestion flag, each of a time for which a value indicating congestion continues and a time for which a value indicating no congestion continues as a time block and creating a time block list.

[Supplementary Note 5]

The privilege issuing apparatus according to Supplementary note 4, wherein

the security checkpoint congestion predicting unit acquires the number of arrivals at the security checkpoint per unit time as the prediction result of congestion, and

the binarizing unit sets the congestion flag to the value indicating congestion when the number of arrivals per the unit time is equal to or greater than a threshold and sets the congestion flag to the value indicating no congestion when the number of arrivals per the unit time is less than the threshold.

[Supplementary note 6]

The privilege issuing apparatus according to Supplementary note 4 or 5, wherein the time block list alternately includes a first time block for which the value of the congestion flag indicating congestion continues and a second time block for which the value of the congestion flag indicating no congestion continues.

[Supplementary Note 7]

The privilege issuing apparatus according to Supplementary note 6, wherein

the privilege determining unit comprises:
a time block deciding unit configured to specify a time block including the security checkpoint arrival time;
a privilege condition determining unit configured to determine, depending on whether the specified time block including the security checkpoint arrival time is the first time block or the second time block, a privilege condition including a location in which the privilege information is available and the validity period; and
a privilege selecting unit configured to select, depending on the location, in which the privilege information is available, determined by the privilege condition determining unit, the privilege information to be issued.

[Supplementary Note 8]

The privilege issuing apparatus according to Supplementary note 7, wherein the privilege condition determining unit determines a period of a time block one block ahead of the time block including the security checkpoint arrival time as the validity period.

[Supplementary Note 9]

The privilege issuing apparatus according to Supplementary note 8, wherein the privilege condition determining unit determines that the area where the airport user can stop at before the airport user passes through the security checkpoint is the location in which the privilege information is available when the time block including the security checkpoint arrival time is the first time block, and determines that the area where the airport user can stop at after the airport user passes through the security checkpoint is the location in which the privilege information is available when the time block including the security checkpoint arrival time is the second time block.

[Supplementary Note 10]

The privilege issuing apparatus according to Supplementary note 7, further comprising an airport staying start time acquiring unit configured to acquire a staying start time of the airport user in an airport, wherein

the time block deciding unit further specifies a time block including the staying start time, and

the privilege determining unit further comprises a privilege issuance necessity deciding unit configured to decide, depending on whether the staying start time and the security checkpoint arrival time are included in the same time block, whether issuance of the privilege information is necessary.

[Supplementary Note 11]

The privilege issuing apparatus according to Supplementary note 10, wherein the privilege issuance necessity deciding unit decides, when the staying start time and the security checkpoint arrival time are included in the same time block, not to issue the privilege information.

[Supplementary Note 12]

The privilege issuing apparatus according to Supplementary note 10 or 11, wherein the privilege issuance necessity deciding unit decides, when the time block including the staying start time is a time block one block ahead of the time block including the security checkpoint arrival time, to issue the privilege information for the time block one block ahead.

[Supplementary Note 13]

The privilege issuing apparatus according to Supplementary note 12, wherein the privilege condition determining unit determines a period of the time block one block ahead as the validity period, determines, when the time block one block ahead is the first time block, the area where the airport user can stop at before the airport user passes through the security checkpoint as the location in which the privilege information is available, and determines, when the time block one block ahead is the second time block, the area where the airport user can stop at after the airport user passes through the security checkpoint as the location in which the privilege information is available.

[Supplementary Note 14]

The privilege issuing apparatus according to any one of Supplementary notes 10 to 13, wherein the privilege issuance necessity deciding unit decides, when the time block including the staying start time is a time block two or more blocks ahead of the time block including the security checkpoint arrival time, to issue the privilege information for each of time blocks from the time block including the staying start time to the time block one block ahead of the time block including the security checkpoint arrival time.

[Supplementary Note 15]

The privilege issuing apparatus according to Supplementary note 14, wherein the privilege condition determining unit determines a period of the each of the time blocks from the time block including the staying start time to the time block one block ahead of the time block including the security checkpoint arrival time as the validity period, determines, when the each of the time blocks is the first time block, the area where the airport user can stop at before the airport user passes through the security checkpoint as the location in which the privilege information is available, and determines, when the each of the time blocks is the second time block, the area where the airport user can stop at after the airport user passes through the security checkpoint as the location in which the privilege information is available.

[Supplementary Note 16]

The privilege issuing apparatus according to any one of Supplementary notes 1 to 15, wherein the security checkpoint arrival time calculating unit calculates a time before a predetermined time from the scheduled boarding time as the security checkpoint arrival time.

[Supplementary Note 17]

A privilege issuing method comprising:

acquiring a scheduled boarding time of an airport user;

calculating, based on the scheduled boarding time, a security checkpoint arrival time at which the airport user arrives at a security checkpoint;

acquiring a time series prediction of congestion at the security checkpoint;

determining, based on the security checkpoint arrival time and the time series prediction of congestion, privilege information to be issued to the airport user and a validity period for which the privilege information is valid; and

issuing the determined privilege information to the airport user.

[Supplementary Note 18]

A program causing a computer to execute processing of:

acquiring a scheduled boarding time of an airport user;

calculating, based on the scheduled boarding time, a security checkpoint arrival time at which the airport user arrives at a security checkpoint;

acquiring a time series prediction of congestion at the security checkpoint;

determining, based on the security checkpoint arrival time and the time series prediction of congestion, privilege information to be issued to the airport user and a validity period for which the privilege information is valid; and

issuing the determined privilege information to the airport user.

This application is based upon and claims the benefit of priority from Japanese Patent Application No. 2019-026104, filed on Feb. 15, 2019, the disclosure of which is incorporated herein in its entirety by reference.

### REFERENCE SIGNS LIST

10 PRIVILEGE ISSUING APPARATUS
11 SCHEDULED BOARDING TIME ACQUIRING MEANS
12 SECURITY CHECKPOINT ARRIVAL TIME CALCULATING MEANS
13 SECURITY CHECKPOINT CONGESTION PREDICTING MEANS
14 PRIVILEGE DETERMINING MEANS
15 PRIVILEGE ISSUING MEANS
100 PRIVILEGE ISSUING SYSTEM
110 PRIVILEGE ISSUING APPARATUS
111 SCHEDULED BOARDING TIME ACQUIRING MEANS
112 SECURITY CHECKPOINT FINAL ARRIVAL TIME CALCULATING MEANS
113 SECURITY CHECKPOINT CONGESTION PREDICTING MEANS
114 PRIVILEGE DETERMINING MEANS
115 PRIVILEGE ISSUING MEANS
116 CHECK-IN START TIME CALCULATING MEANS
131 SECURITY CHECKPOINT CONGESTION PREDICTION ACQUIRING MEANS
132 BINARIZING MEANS
133 TIME BLOCK CREATING MEANS
134 PREDICTION RESULT STORING MEANS
141 TIME BLOCK DECIDING MEANS
142 PRIVILEGE CONDITION DETERMINING MEANS
143 PRIVILEGE SELECTING MEANS
144 PRIVILEGE LIST STORING MEANS
145 PRIVILEGE ISSUANCE NECESSITY DECIDING MEANS
150 PRIVILEGE ACQUIRING APPARATUS

151 PRIVILEGE ACQUIRING MEANS
152 PRIVILEGE DISPLAYING MEANS
161 MAXIMUM STAYING TIME DETERMINING MEANS
162 CHECK-IN START TIME OUTPUTTING MEANS
201 CHECK-IN AREA
202 BOARDING AREA
203 SECURITY CHECKPOINT

What is claimed is:

1. A privilege issuing apparatus comprising:
hardware, including a processor and memory;
a scheduled boarding time acquiring unit implemented at least by the hardware and configured to acquire a scheduled boarding time of an airport user;
a security checkpoint arrival time calculating unit implemented at least by the hardware and configured to calculate, based on the scheduled boarding time, a security checkpoint arrival time at which the airport user arrives at a security checkpoint;
a security checkpoint congestion predicting unit implemented at least by the hardware and configured to acquire a time series prediction of congestion at the security checkpoint;
a privilege determining unit implemented at least by the hardware and configured to determine, based on the security checkpoint arrival time and the time series prediction of congestion, privilege information to be issued to the airport user and a validity period for which the privilege information is valid; and
a privilege issuing unit implemented at least by the hardware and configured to issue, to the airport user, the privilege information determined by the privilege determining unit.

2. The privilege issuing apparatus according to claim 1, wherein the privilege determining unit determines to issue privilege information available in an area where the airport user can stop at before the airport user passes through the security checkpoint when the security checkpoint is congested in the validity period and determines to issue privilege information available in an area where the airport user can stop at after the airport user passes through the security checkpoint when the security checkpoint is not congested in the validity period.

3. The privilege issuing apparatus according to claim 1, wherein the security checkpoint congestion predicting unit outputs, to the privilege determining unit, information indicating a time period for which the security checkpoint is congested and information indicating a time period for which the security checkpoint is not congested as the time series prediction of congestion.

4. The privilege issuing apparatus according to any one of claim 1, wherein
the security checkpoint congestion predicting unit comprises:
a security checkpoint congestion prediction acquisition unit implemented at least by the hardware and configured to acquire a prediction result of congestion at the security checkpoint predicted in time series;
a binarizing unit implemented at least by the hardware and configured to create, based on the prediction result of congestion, a congestion flag indicating whether the security checkpoint is congested; and
a time block list creating unit implemented at least by the hardware and configured to define, based on the congestion flag, each of a time for which a value indicating congestion continues and a time for which a value indicating no congestion continues as a time block and creating a time block list.

5. The privilege issuing apparatus according to claim 4, wherein
the security checkpoint congestion prediction acquisition unit acquires the number of arrivals at the security checkpoint per unit time as the prediction result of congestion, and
the binarizing unit sets the congestion flag to the value indicating congestion when the number of arrivals per the unit time is equal to or greater than a threshold and sets the congestion flag to the value indicating no congestion when the number of arrivals per the unit time is less than the threshold.

6. The privilege issuing apparatus according to claim 4, wherein the time block list alternately includes a first time block for which the value of the congestion flag indicating congestion continues and a second time block for which the value of the congestion flag indicating no congestion continues.

7. The privilege issuing apparatus according to claim 6, wherein
the privilege determining unit comprises:
a time block deciding unit implemented at least by the hardware and configured to specify a time block including the security checkpoint arrival time;
a privilege condition determining unit implemented at least by the hardware and configured to determine, depending on whether the specified time block including the security checkpoint arrival time is the first time block or the second time block, a privilege condition including a location in which the privilege information is available and the validity period; and
a privilege selecting unit implemented at least by the hardware and configured to select, depending on the location, in which the privilege information is available, determined by the privilege condition determining unit, the privilege information to be issued.

8. The privilege issuing apparatus according to claim 7, wherein the privilege condition determining unit determines a period of a time block one block ahead of the time block including the security checkpoint arrival time as the validity period.

9. The privilege issuing apparatus according to claim 8, wherein the privilege condition determining unit determines that the area where the airport user can stop at before the airport user passes through the security checkpoint is the location in which the privilege information is available when the time block including the security checkpoint arrival time is the first time block, and determines that the area where the airport user can stop at after the airport user passes through the security checkpoint is the location in which the privilege information is available when the time block including the security checkpoint arrival time is the second time block.

10. The privilege issuing apparatus according to claim 7, further comprising an airport staying start time acquiring unit implemented at least by the hardware and configured to acquire a staying start time of the airport user in an airport, wherein
the time block deciding unit further specifies a time block including the staying start time, and
the privilege determining unit further comprises a privilege issuance necessity deciding unit implemented at least by the hardware and configured to decide, depending on whether the staying start time and the security checkpoint arrival time are included in the same time block, whether issuance of the privilege information is necessary.

11. The privilege issuing apparatus according to claim 10, wherein the privilege issuance necessity deciding unit decides, when the staying start time and the security checkpoint arrival time are included in the same time block, not to issue the privilege information.

12. The privilege issuing apparatus according to claim 10, wherein the privilege issuance necessity deciding unit decides, when the time block including the staying start time is a time block one block ahead of the time block including the security checkpoint arrival time, to issue the privilege information for the time block one block ahead.

13. The privilege issuing apparatus according to claim 12, wherein the privilege condition determining unit determines a period of the time block one block ahead as the validity period, determines, when the time block one block ahead is the first time block, the area where the airport user can stop at before the airport user passes through the security checkpoint as the location in which the privilege information is available, and determines, when the time block one block ahead is the second time block, the area where the airport user can stop at after the airport user passes through the security checkpoint as the location in which the privilege information is available.

14. The privilege issuing apparatus according to claim 10, wherein the privilege issuance necessity deciding unit decides, when the time block including the staying start time is a time block two or more blocks ahead of the time block including the security checkpoint arrival time, to issue the privilege information for each of time blocks from the time block including the staying start time to the time block one block ahead of the time block including the security checkpoint arrival time.

15. The privilege issuing apparatus according to claim 14, wherein the privilege condition determining unit determines a period of the each of the time blocks from the time block including the staying start time to the time block one block ahead of the time block including the security checkpoint arrival time as the validity period, determines, when the each of the time blocks is the first time block, the area where the airport user can stop at before the airport user passes through the security checkpoint as the location in which the privilege information is available, and determines, when the each of the time blocks is the second time block, the area where the airport user can stop at after the airport user passes through the security checkpoint as the location in which the privilege information is available.

16. The privilege issuing apparatus according to claim 1, wherein the security checkpoint arrival time calculating unit calculates a time before a predetermined time from the scheduled boarding time as the security checkpoint arrival time.

17. A privilege issuing method comprising:
acquiring a scheduled boarding time of an airport user;
calculating, based on the scheduled boarding time, a security checkpoint arrival time at which the airport user arrives at a security checkpoint;
acquiring a time series prediction of congestion at the security checkpoint;
determining, based on the security checkpoint arrival time and the time series prediction of congestion, privilege information to be issued to the airport user and a validity period for which the privilege information is valid; and
issuing the determined privilege information to the airport user.

18. A non-transitory computer-readable medium storing a program causing a computer to execute processing of:
acquiring a scheduled boarding time of an airport user;
calculating, based on the scheduled boarding time, a security checkpoint arrival time at which the airport user arrives at a security checkpoint;
acquiring a time series prediction of congestion at the security checkpoint;
determining, based on the security checkpoint arrival time and the time series prediction of congestion, privilege information to be issued to the airport user and a validity period for which the privilege information is valid; and
issuing the determined privilege information to the airport user.
